(19) United States
(12) Patent Application Publication
(10) Pub. No.: US 2025/0153724 A1
(43) Pub. Date: May 15, 2025

(54) Method, Device, and Computer Program Product for Operating a Vehicle

(71) Applicant: Bayerische Motoren Werke Aktiengesellschaft, Muenchen (DE)

(72) Inventor: Alexander AUGST, Muenchen (DE)

(21) Appl. No.: 18/928,264

(22) Filed: Oct. 28, 2024

(30) Foreign Application Priority Data
Nov. 9, 2023 (DE) 10 2023 131 070.4

(51) Int. Cl. B60W 50/06; B60W 10/18; B60W 10/20; B60W 10/30; B60W 60/00

(52) U.S. Cl. CPC B60W 50/06; B60W 10/18; B60W 10/20; B60W 10/30; B60W 60/001

(57) ABSTRACT

A method for operating a vehicle is provided, in which a target to be achieved by at least one vehicle functionality is ascertained and first input data are generated depending on the target. A first generative pre-trained transformer is operated depending on the first input data in order to generate first output data. Second input data are generated depending on the first output data. The first generative pre-trained transformer is operated depending on second input data in order to generate second output data. Alternatively or additionally, at least one second generative pre-trained transformer is actuated depending on the second input data in order to generate the second output data. Finally, the vehicle functionality is operated depending on the second output data.

### CROSS REFERENCE TO RELATED APPLICATION

This application claims priority under 35 U.S.C. § 119 from German Patent Application No. DE 10 2023 131 070.4, filed Nov. 9, 2023, the entire disclosure of which is herein expressly incorporated by reference.

### BACKGROUND AND SUMMARY

The invention relates to a method for operating a vehicle. The invention relates to a device and computer program product for operating a vehicle.

In particular neural networks which are designed to actuate vehicle functionalities are known from the prior art. For example, DE 10 2004 004 168 A1 discloses such a neural network. The neural network is designed to actuate a warning flashing function or direction flashing function when a specified event occurs.

DE 10 2017 210 156 B4 discloses a device for actuating a vehicle module in which an artificial intelligence is used. The artificial intelligence is in particular a neural network and is designed to evaluate sensor signals as part of an evaluation device and to actuate the vehicle module accordingly.

A further device for actuating a vehicle module is known from DE 10 2017 210 151 A1. The device uses an artificial intelligence, in particular a neural network, to monitor the function of the vehicle module.

Furthermore, a neural network is known from DE 10 2021 132 588 A1, which is designed to control a drive system of a vehicle. The neural network is designed to control the drive system of the vehicle in dependence on parameters of the omissions of the vehicle.

The outputs of machine learning methods, such as neural networks, can be poorly predictable; in particular, the more general the model is, i.e. the more diverse the goals or intended uses of the model are. Thus, for example, models which have been trained to identify specific features can supply false-positive or flawed results due to overfitting. Such effects, in particular a certain unpredictability, make it difficult to use machine learning methods in the control of important elements, for example, of functions of a vehicle. Furthermore, decisions made by machine learning methods can sometimes only be comprehensible with difficulty. These disadvantages are expressed more strongly the more universal and/or larger the artificial intelligence is. Disadvantages can result with respect to a use of artificial intelligence in vehicles, because a very high level of diversity of possible targets can be tracked in vehicles, which can only be served with difficulty using a so-called weak artificial intelligence.

The object of the invention is therefore to specify a method, a device, and a computer program product for operating a vehicle, which overcome the above-mentioned disadvantages of the known prior art.

The object is achieved by the subjects of the independent claims. Advantageous embodiments are described, inter alia, in the dependent claims. It is to be noted that additional features of a claim dependent on an independent claim, without the features of the independent claim or in combination with only a subset of the features of the independent claim, can form a separate invention independent of the combination of all features of the independent claim, which can be made the subject matter of an independent claim, a divisional application, or a subsequent application. This applies in the same manner to technical teachings described in the description which can form an invention independent of the features of the independent claims.

In the proposed method for operating a vehicle, a target to be achieved by means of at least one vehicle functionality is ascertained and first input data are generated depending on the target. A first generative pre-trained transformer is operated depending on the first input data in order to generate first output data. Second input data are generated depending on the first output data. In a first embodiment, the first generative pre-trained transformer is operated depending on second input data in order to generate second output data. Alternatively or additionally, at least one second generative pre-trained transformer is actuated depending on the second input data in order to generate the second output data. Finally, the vehicle functionality is operated depending on the second output data.

The target can comprise a target value or be a target value which is to be sought, achieved, or maintained. For example, a target value can be a target value for a vehicle functionality, in particular a setpoint value. For example, the target value can relate to a speed of the vehicle, a lane guidance, following a specific, for example, selectable object, following a navigation route, or a temperature in the vehicle interior. The ascertainment of the target can in particular consist of defining the target, for example, in the form of a target value which is specified by a user, or inputting it in arbitrary form. The target can be ascertained or processed as corresponding target data. The first input data can be these target data or can be ascertained depending on target data in an expedient intermediate step.

The term “generative pre-trained transformer” is also called GPT. The first generative pre-trained transformer and/or the second generative pre-trained transformer can each also be or comprise a neural network or can form a part of a neural network. The neural network or the relevant parts, such as layers of the neural network, can be designed according to one or more features typical for generative pre-trained transformers, in particular with respect to their architecture and parameters.

In particular the first and/or second generative pre-trained transformer is a generative, in particular statistical model, in particular a model post-trained on a specific type of the vehicle, the specific vehicle, a specific user and/or operator of the vehicle. Alternatively, the first and/or second generative pre-trained transformer is/are constructed on the basis of and/or is controlled by such a post-trained model. In particular, the post-trained model can comprise or be a language model or a model having language assistance, in particular a so-called large language model.

The term “operate” the (first, second, third) generative pre-trained transformer can comprise stimulating, setting (for example, changing the operating mode and/or settings), and/or prompting the (respective) generative pre-trained transformer. The operation is carried out in particular by providing or inputting the respective input data at the input layer.

The term “operating” the vehicle functionality can comprise or be actuating, setting (for example, changing the operating mode and/or settings), pausing, deactivating, or (for example, briefly) stopping or adapting an (otherwise due) action, triggering, or reaction of the vehicle function.

The operation of the vehicle functionality can comprise or be a case-specific adaptation of qualitative and/or quantitative parameters of the vehicle functionality. This can in particular take place permanently or until canceled. The term “vehicle functionality” can be interpreted as one or more performance features, in particular features, of one or more respective vehicle functionalities or a combination thereof.

The term “control unit” is interpreted in the scope of the present document as an (at least partially separate, for example, provided for a vehicle functionality) computing unit (such as a controller or a part thereof) or a software module, a or a part of a computing unit (for example, a processor or hardware module, for example, within an integration control unit).

The proposed method takes place in two essential steps. Initially, control data, for example, a stimulus or a prompt are generated in the form of the first output data from the ascertained target, which are then further processed in the form of the second input data in order to operate the vehicle functionality.

In the first alternative embodiment of the method, the first generative pre-trained transformer operates itself in that it generates the control data (for example, stimulus, setting data, prompt), for example, on the basis of the target (for example, target data), which control data form a part of the input for the same first generative pre-trained transformer. The first generative pre-trained transformer, at least in a first pass, can generate a part of this input for itself, at least for a further second pass. This can use the first output data (also to be interpreted as data on the basis of the first output data), which are used as the second input data (i.e., input), in particular for the same or another input (for example, part of the input layer) of the first pre-trained transformer.

In the second embodiment of the method, the first generative pre-trained transformer operates at least one or preferably several of the second generative pre-trained transformers. One or more (of the one or more) second generative pre-trained transformers can in particular (each, optionally) be a (comparatively narrowly) specialized generative pre-trained transformer. For example, this can be specialized, in particular optimized, for the operation of a specific functionality, or can execute or form at least a part of the vehicle functionality.

The two above-mentioned embodiments of the proposed method can preferably be combined with one another as desired. The overall resulting advantages can thus be increased.

The first generative pre-trained transformer can be operated on a level abstracted from the vehicle functionalities to be operated and/or from specific control commands, for example, as an agent in the meaning of the user.

One of the advantages of the proposed method is that due to the so to speak two-stage execution, the outputs of the generative pre-trained transformers and thus the results of the method are better protectable and comprehensible. Possible risks upon the use of artificial intelligence in the vehicle can thus be better managed. In particular, the two-stage execution enables the use of the artificial intelligence in comparatively critical vehicle functionalities requiring a high level of precision or reliability.

The functional principle described in the present document and the features of the device or the described architecture additionally have the advantage that the user, for example, a vehicle occupant, acts, in particular interacts, with a central instance and on an abstract plane or through abstract targets. Addressing comparatively abstract targets, instead of specific control commands for specific vehicle functionalities, or controlling them directly or manually can thus be enabled for the vehicle occupants, for example. In particular, the first generative pre-trained transformer-with or without action of the vehicle occupant-can form one or more partial tasks depending on the target. The level of user-friendliness of the device or the individual vehicle functionalities can thus be further increased.

In a further embodiment, the first generative pre-trained transformer is designed to generate the first output data in consideration of driving situation data corresponding to a driving situation relating to the vehicle, of occupant status data corresponding to the status of a vehicle occupant and/or of vehicle status data corresponding to the status of the vehicle, in particular the status of one or more devices or vehicle functionalities of the vehicle. The driving situation, the status of the vehicle occupants, and/or the status of the vehicle can be detected, for example, by a sensor of the vehicle and provided in the form of the driving situation data or the occupant status data, in consideration of which the first output data are generated. The term “driving situation” can be understood in the scope of the present document, for example, as a specific situation characterized by an arrangement, action, or interaction of road users or by specific driving parameters of road users, in particular on the level of observation of specific objects. In particular, the meaning of the term “driving situation” therefore differs from a meaning of the term “traffic situation” often used colloquially, which rather corresponds to the summarizing, general, and/or statistical categories such as “free traffic”, “dense traffic”, “slow moving traffic”, “congestion”, “tail of congestion”, etc.

The term “driving situation” can furthermore be understood in the context of this document also as parameters of the driving situation. One or more parameters of the driving situation can characterize, in particular represent, a specific pattern (also to be understood as a data pattern), for example, a pattern characteristic of an arrangement and/or speed of objects and/or a pattern of the parameters of the driving situation. The driving situation can also be characterized by a spatial pattern of the so-called free spaces in the surroundings of the vehicle or by corresponding parameters.

The at least one driving situation is preferably characterized by one or more of the features listed hereinafter:
a specific spatial distribution of the road users and/or the movement parameters of the road users, in particular an arrangement pattern of the road users in the surroundings of the vehicle;
a specific spatial distribution of immobile objects in the surroundings of the vehicle;
a relative position and/or movement in relation to specific types of lane markings, traffic signs, traffic signal systems;
information about the right-of-way of the vehicle, in particular in relation to actual road users and/or road users which at least potentially can come from specific directions, for example, a crossing street from the right or from the left;
information on an action of a road user, for example, exceeding a limiting value, in the surroundings of the vehicle, such as honking, flashing lights, pushing in, overtaking the vehicle, an overtaking attempt, and the like.

Furthermore, the driving situation can also be characterized by one or more parameters in conjunction with relevant traffic rules, traffic signs, rights-of-way, traffic signals, and/or traffic light phases.

The driving situation described in the present document can comprise an arbitrary combination of the described features.

A temporal and/or spatial change characteristic, in particular a gradient, such as a temporal and/or spatial gradient of the respective parameter, in particular parameter value, can also apply or be considered as one or more parameters of the driving situation.

For example, driving situation parameters based on surroundings sensor data and/or from information transmitted to the vehicle can also be taken into consideration, for example information which was transmitted from a further road user by means of a car-to-car or car-to-X. The surroundings sensor data can be data processed in a specific manner of a surroundings-detecting sensor, in particular of a sensor system of at least one vehicle.

Alternatively or additionally, traffic regulation information characteristic for one or more traffic regulations can be ascertained and taken into consideration in the method. The traffic regulation information can correspond, for example, to the legal regulations and/or logic. The traffic regulations can be, for example, specific for the location, in particular country, province, or municipality of the vehicle.

The status of the vehicle is understood, for example, as one or more odometry parameters, for example, movement parameters such as the current speed or the current longitudinal and lateral acceleration of the vehicle. Further information can however also be understood as the status of the vehicle, for example, a fill level or state of charge of one or more energy storage devices of the vehicle or chassis parameters. Furthermore, the operating status, in particular operating mode or a current driving mode of the vehicle can be ascertained and taken into consideration.

For example, the first generative pre-trained transformer is also operated depending on the described data. The first output data can be generated, which take into consideration the respective context. The operation of the vehicle, in particular a vehicle functionality, can thus take place in a manner better adaptable to the situation, more precisely, or more reliably.

In a further embodiment, the second generative pre-trained transformer is designed to operate the vehicle functionality, in particular to actuate, set, and/or execute it. In this embodiment, the second generative pre-trained transformer can, for example, generate control data which are transmitted directly or indirectly, in particular after an expedient intermediate step, to the vehicle functionality and/or input thereby.

In a further embodiment, two or more second generative pre-trained transformers are operated depending on the second input data in order to each generate second output data. Third input data are generated depending on the second output data. The first generative pre-trained transformer is operated depending on the third input data in order to generate third output data. The vehicle functionality is operated depending on the third output data. This enables the first generative pre-trained transformer to check whether the outputs of the one or more second generative pre-trained transformers are expedient, reasonable, and/or relevant individually or in combination in order to achieve the target and/or are harmless. In particular, the first pre-trained transformer can be designed to filter out outputs which are not sufficiently expedient and/or critical and/or process them to form expedient and/or noncritical outputs. The first generative pre-trained transformer can also be designed to fulfill the role of a supervisory authority. For example, outputs which are used as the basis for the execution of the vehicle functionality can be made more precise and/or better protectable in this case. In addition, risks in conjunction with the use of artificial intelligence in the vehicle can be further reduced.

In a further embodiment, the first generative pre-trained transformer is designed to generate the third output data in consideration of driving situation data which correspond to a driving situation relating to the vehicle, of occupant status data which correspond to the status of a vehicle occupant, and/or of vehicle status data which correspond to the status of the vehicle, in particular the status of one or more devices or vehicle functionalities of the vehicle. In this embodiment, the first generative pre-trained transformer processes and/or filters the outputs of the second generative pre-trained transformer in consideration of the situational context, for example the current driving situation of the vehicle. This increases the reliability with which the vehicle functionality is executed still further.

In a further embodiment, the vehicle functionality is a vehicle functionality influencing the movement of the vehicle, in particular a drive system, a braking system and/or steering system and/or a maneuver execution system. For example, a drive system can be actuated in order to operate the drive system more fuel efficiently. In particular, however, an actuator of the vehicle is also directly actuated in order to influence the movement of the vehicle, for example to accelerate or decelerate the vehicle.

In a further embodiment, the vehicle functionality is a navigation system and/or a vehicle functionality related to the assisted, automated, or autonomous driving of the vehicle. Assisted driving is understood in this document as the degrees of automation 1 and 2 according to the German Federal Highway Research Institute. Automated driving is understood in this document as the degrees of automation 2, 2+, and 3 according to the German Federal Highway Research Institute. Autonomous driving is understood in this document as the degrees of automation 4 and 5 according to the German Federal Highway Research Institute. Driving assistance systems in the meaning of this document are, for example, an adaptive cruise control, a line keeping assistant, a parking aid, a longitudinal guidance assistant, or a combination of the above-mentioned driving assistance systems, for example, a congestion assistant.

For example, a specific driving assistance system can be activated and/or deactivated as a result of the method as the vehicle functionality. Alternatively or additionally, in this embodiment, an actuator of the vehicle can also be directly actuated in order to enable the assisted, automated, or autonomous driving of the vehicle.

In a further embodiment, the vehicle functionality is a multimedia system, an infotainment system, a personalization system, and/or a comfort function of the vehicle, in particular an air conditioner, a ventilation function, a scenting function, and/or one or more adjustable devices in the vehicle interior, in particular one or more segments of a seat or a steering wheel. This embodiment enables the user to operate a number of practical and comfort functions particularly easily, in particular to control, operate, and/or set them matching with the context and/or individual requirements. In particular, this embodiment can improve the handling of functionalities of different types. For example, at least two or three vehicle functionalities or vehicle functionalities of at least two or three different types can be operated more or less centrally and using comparatively abstract or general control data here.

In a further embodiment, the first generative pre-trained transformer is post-trainable depending on driving situation data which correspond to a driving situation relevant to the vehicle, on occupant status data which correspond to the status of a vehicle occupant, and/or on vehicle status data which correspond to the status of the vehicle, in particular the status of one or more devices or vehicle functionalities of the vehicle. Alternatively or additionally, the first generative pre-trained transformer is post-trained depending on driving situation data which correspond to a driving situation relevant to the vehicle, on occupant status data which correspond to the status of a vehicle occupant, and/or on vehicle status data which correspond to the status of the vehicle, in particular the status of one or more devices or vehicle functionalities of the vehicle. Due to the post-training depending on or on the basis of the driving situation data or the status data, the result of the method can be adapted better to the respective user, vehicles, contexts, usage types, or usage scenarios of the vehicle and/or the quality, grade, or precision of the result, for example, the output of the first generative pre-trained transformer is improved. In addition, the reliability with which the vehicle functionality is executed is increased still further.

The invention moreover relates to a device for operating a vehicle. The device comprises a first control unit designed to ascertain a target to be achieved by means of at least one vehicle functionality and to generate first input data depending on the target and a second control unit designed to operate a first generative pre-trained transformer in order to generate first output data depending on the first input data, and to generate second input data depending on the first output data. Either the second control unit is designed to operate the first generative pre-trained transformer in order to generate second output data depending on the second input data. Alternatively or additionally, the device comprises at least one third control unit designed to operate at least one second generative pre-trained transformer depending on the second input data in order to generate the second output data. Either the second control unit and/or the third control unit are designed to operate the vehicle functionality depending on the second output data. In a first embodiment, the second control unit is designed to operate the first generative pre-trained transformer in order to generate second output data depending on the second input data. In a second embodiment, the device comprises at least one third control unit designed to operate at least one second generative pre-trained transformer in order to generate the second output data depending on the second input data. The second control unit and/or the third control unit are designed to operate the vehicle functionality depending on the second output data. A first part of the second output data can be generated by one or more second generative pre-trained transformers and/or a second part of the second output data can be generated by one or more second generative pre-trained transformers.

The device has the same advantages as the claimed method. In particular, the device can be refined using the features of the dependent claims directed to the method. Furthermore, the above-described method can be refined using features which are described in this document in conjunction with the device.

The invention furthermore relates to a computer program product. The computer program product comprises a computer program designed to execute the above-described method when the computer program is executed on one or more control units.

The computer program product has the same advantages as the claimed method and the claimed device. In particular, the computer program product can be refined using the features of the dependent claims directed to the method or the devices. Furthermore, the above-described method and the above-described device can be refined using features which are described in this document in conjunction with the computer program product.

According to one embodiment, the computer program comprises a first generative pre-trained transformer and/or at least one second generative pre-trained transformer, in particular the respective pre-trained model, and/or logic and/or data for training, in particular post-training and/or for operating the first and/or second generative pre-trained transformer.

The computer program product can be designed as an update of a previous computer program which is downloaded to control units of the vehicle, for example, in the context of a functional expansion, for example, in the context of a so-called “remote software update”, in particular by means of a data connection.

Exemplary embodiments of the invention are explained in more detail hereinafter on the basis of the figures. In the figures:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a schematic representation of a device for operating a vehicle;

FIG. 2 shows a further schematic representation of the device for operating a vehicle;

FIG. 3 shows a flow chart of a method for operating the vehicle according to a first exemplary embodiment;

FIG. 4 shows a flow chart of a method for operating the vehicle according to a second exemplary embodiment; and

FIG. 5 shows a flow chart of a method for operating the vehicle according to a third exemplary embodiment.

### DETAILED DESCRIPTION OF THE DRAWINGS

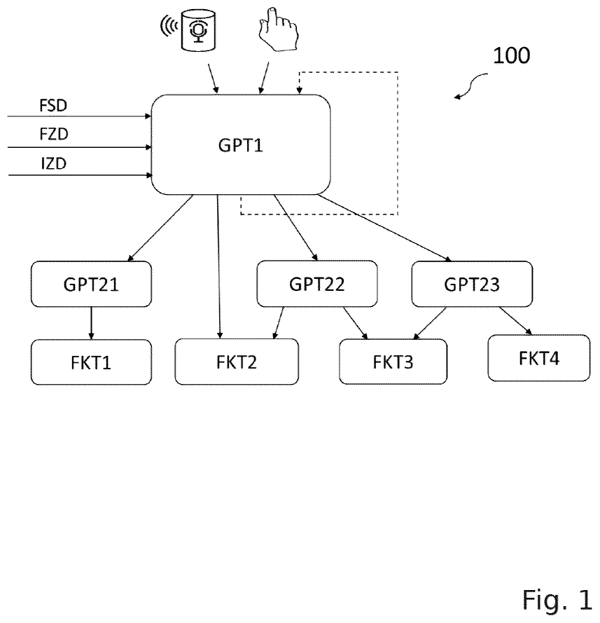

FIG. 1 shows a schematic representation of a device 100 for operating a vehicle 102.

The device 100 is used to fulfill a target specifiable by a vehicle user by means of one or more vehicle functionalities FKT1, FKT2, FKT3, FKT4, for example, in the most expedient and/or matching manner possible for the vehicle user. Furthermore, information operative connections between generative pre-trained transformers GPT1, GPT21, GPT22, GPT23 are shown. These solid arrows designate a preferred proposed order of the steps here. Furthermore, the arrows can also mean that the unit or step which follows the arrow is executed depending on the result of the unit or step at which the arrow begins. The method can in particular only comprise a part of the units or the illustrated sequence and/or also further steps.

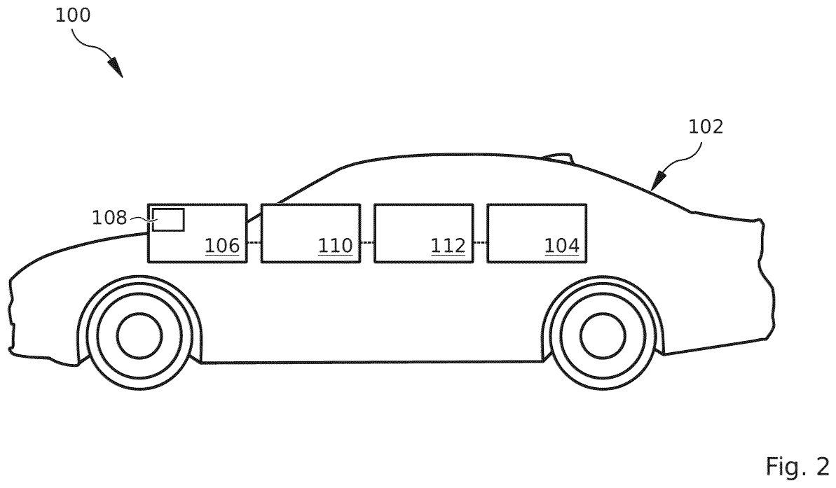

FIG. 2 shows a further schematic representation of the device 100 for operating the vehicle 102.

FIG. 2 shows the one or more vehicle functionalities FKT1, FKT2, FKT3, FKT4 solely by way of example as a single functional unit 104 of the vehicle 102, which is actuated in order to execute the vehicle functionality. The target can in particular comprise or be seeking, achieving, or maintaining a target value determinable, for example, by the user of the vehicle. The target can be able to be input or formulated more or less specifically or comparatively abstractly, for example, without naming a specific action and/or target value, in particular in quantitative form. For example, the target can be abstract, in particular abstracted from a vehicle functionality, for example, from naming the vehicle functionality.

A first control unit 106 of the device 100 is designed to ascertain the target, for example, as target data, and to generate first input data depending on the target. Solely by way of example, the first control unit 106 shown comprises an input unit 108. The input unit 108 is designed to enable the reception, the input, or the processing of the target contained in a user request by the first control unit 106. The first input data are in particular generated in text form or in spoken form (for example, based on natural or at least partially formalized speech) as a prompt. Alternatively, the first input data can be generated in any form which is processable by the first generative pre-trained transformer GPT1, i.e., in a form usable as an input for one of the generative pre-trained transformers GPT1, GPT21, GPT22, GPT23. Alternatively or additionally, the first input data, for example representing the text information or speech information or otherwise, can also be generated in the form of tokens which are processable by a generative pre-trained transformer GPT1, GPT21, GPT22, GPT23.

A second control unit 110 is designed to operate a first generative pre-trained transformer GPT1. The first generative pre-trained transformer GPT1 is trained to process the first input data in order to generate first output data. The second control unit 110 is furthermore designed to generate the first output data in accordance with second input data. These second input data correspond here to an instruction to further generative pre-trained transformers GPT21, GPT22, GPT23. In this way, the target is so to speak transformed or translated into a form comprehensible for machine learning methods, for example language. In particular in the case of abstract targets or targets formulated by a vehicle user, such a transformation leads to better results since in this way standardization is achieved if necessary.

The device 100 shown in FIG. 1 comprises, solely by way of example, a third control unit 112, which is designed to operate at least one or more second generative pre-trained transformers GPT21, GPT22, GPT23. The second generative pre-trained transformers GPT21, GPT22, GPT23 are trained to process the second input data in order to generate second output data. The second output data correspond, for example, more or less specifically, directly, and/or related to the specific vehicle functionality FKT1, FKT2, FKT3, FKT4, for example, control data to the functional unit 104 to execute the vehicle functionality FKT1, FKT2, FKT3, FKT4.

In particular, the second generative pre-trained transformers GPT21, GPT22, GPT23, in particular compared to the first generative pre-trained transformer GPT1, are specialized generative pre-trained transformers which are optimized narrowly and/or to specific tasks with specific functionalities. These can have been only trained, for example, on the basis of a reduced training data set tailored, for example, to the vehicle functionality FKT1, FKT2, FKT3, FKT4 and/or can be limited in essential aspects to the vehicle functionality FKT1, FKT2, FKT3, FKT4 to be executed. The necessity can thus be eliminated for the vehicle user, in particular the vehicle occupant, of formulating specific control commands. Rather, the vehicle user can specify a substantially more abstract target.

The third control unit 112 can also be designed to process the second output data in order to generate third input data which are in turn transmitted to the second control unit 110. In such an embodiment, the first generative pre-trained transformer GPT1 is configured, in particular trained and/or post-trained, to process the third input data in order to generate third output data. In this way, in particular during the operation of multiple second generative pre-trained transformers GPT21, GPT22, GPT23, the respective outputs of the second generative pre-trained transformers GPT21, GPT22, GPT23 can be improved and/or standardized or adapted better to the target. The third output data then form the basis for the execution of the vehicle functionality FKT1, FKT2, FKT3, FKT4, for example the third output data are control data for the functional unit 104. In one preferred exemplary embodiment, at least a part of the vehicle functionality FKT1, FKT2, FKT3, FKT4 is executed by the one or more (respective) ones of the second generative pre-trained transformers GPT21, GPT22, GPT23.

In a further embodiment, the first generative pre-trained transformer GPT1 is trained to process the second input data itself. This is illustrated in FIG. 1 by a dot-dash line. In other words, the first generative pre-trained transformer GPT1 operates itself in this embodiment, for example, in that it stimulates, controls, or prompts itself or it changes settings or an operating mode in order to generate the second output data.

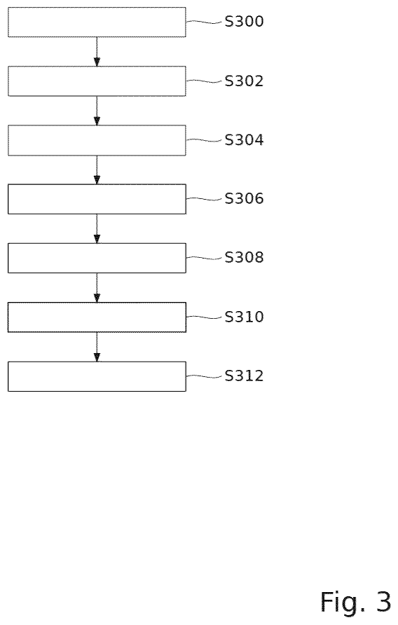

FIG. 3 shows a flow chart of a method for operating the vehicle 102 according to a first exemplary embodiment.

The method is started in step S200. In step S202, the target is ascertained, for example, on the basis of a user input and/or on sensor data. In step S204, first input data are generated on the basis of the target. For example, an abstractly formulated target is converted with the aid of a tokenizer into tokens which are processable by the first generative pre-trained transformer GPT1. In another example, a speech input of a user is received and converted into text which can be input into the first generative pre-trained transformer GPT1.

In step S206, the first generative pre-trained transformer GPT1 generates the first output data on the basis of the first input data. The first generative pre-trained transformer GPT1 processes first input data according to its training in order to generate the first output data. Depending on the first output data, in particular due to the stimulation by the first output data, the second input data are generated here in such a way that they can be input again into the first generative pre-trained transformer GPT1, for example, at the same and/or at another input.

In the method described on the basis of FIG. 3, the second input data are input into the first generative pre-trained transformer GPT1 in step S208 as an input, for example, as a stimulus, prompt, or control data. The first generative pre-trained transformer GPT1 processes the second input data according to its training in order to generate the second output data. In other words, in the described exemplary embodiment, the first generative pre-trained transformer GPT1 at least partially prompts itself in order to generate the second output data. This can be combined with one or more variants in which the first generative pre-trained transformer GPT1 is operated depending on the outputs of one or more of the second generative pre-trained transformers GPT21, GPT22, GPT23. In step S210, the vehicle functionality FKT1, FKT2, FKT3, FKT4 can then be operated on the basis of the second output data, for example, controlled and/or executed. For example, control data, specific settings, or prompts for one or more functional units 104 or vehicle functionalities FKT1, FKT2, FKT3, FKT3, FKT4 of the vehicle 102 are generated as the second output data in order to operate the one or more vehicle functionalities FKT1, FKT2, FKT3, FKT4. The method is ended in step S212.

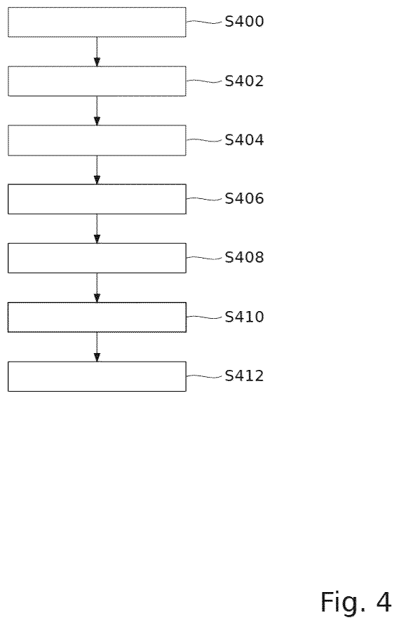

FIG. 4 shows a flow chart of a method for operating the vehicle 102 according to a second exemplary embodiment.

The method according to FIG. 4 differs from the method according to FIG. 2 in that one or more of the second generative pre-trained transformers GPT21, GPT22, GPT23 are used in order to operate the vehicle functionality FKT1, FKT2, FKT3, FKT4, i.e., to control, set, or execute it.

The method is started in step S300. Steps S302 and S304 are identical to steps S202 and S204 according to FIG. 2. In step S306, the first generative pre-trained transformer GPT1 does likewise generate the first output data on the basis of the first input data. In contrast to step S206 according to FIG. 2, however, in the method according to FIG. 4, the second input data are generated in such a way that they can be input again into the second generative pre-trained transformer(s) GPT21, GPT22, GPT23. The second input data are then input into the second generative pre-trained transformer(s) GPT21, GPT22, GPT23 in step S308. The second generative pre-trained transformers GPT21, GPT22, GPT23 then process the second input data according to their training in order to generate the second output data. On the basis of these second output data, in step S310, the one or more vehicle functionalities FKT1, FKT2, FKT3, FKT4 are then executed. The method is ended in step S312.

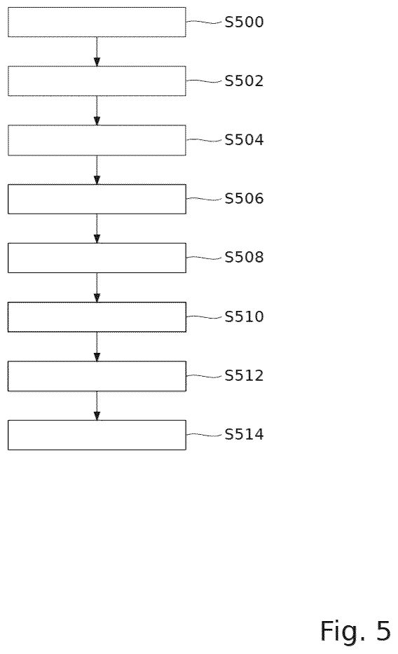

FIG. 5 shows a flow chart of a method for operating the vehicle 102 according to a second exemplary embodiment.

The method according to FIG. 5 differs from the method according to FIG. 4 in that the second output data are not used directly in order to operate the vehicle functionality FKT1, FKT2, FKT3, FKT4.

The method is started in step S400. Steps S402 to S408 are identical to steps S302 to S308 according to FIG. 4. In step S410, third input data for operating the first generative pre-trained transformer GPT1 are generated from the second output data. These data are input into the first generative pre-trained transformer GPT1 as an input, i.e., as a stimulus, prompt, or settings. In other words, the outputs of the various specialized second generative pre-trained transformers GPT21, GPT22, GPT23 can be processed together here, in particular bundled.

The third input data are processed by the first generative pre-trained transformer GPT1 according to its training in order to generate third output data. These third output data are used in step S412 in order to operate the vehicle functionality, i.e., to control, set, and/or execute it. The method is then ended in step S414.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

100 device
102 vehicle
104 functional unit
106 control unit
108 input unit
110, 112 control unit
GPT1, GPT21, GPT22, GPT23, GPT23 pre-trained generative transformer
FKT1, FKT2, FKT3, FKT4 vehicle functionalities

What is claimed is:

1. A method for operating a vehicle, the method comprising:
determining a target to be achieved by a vehicle functionality and generating first input data depending on the target;
operating a first generative pre-trained transformer depending on the first input data in order to generate first output data;
generating second input data depending on the first output data;
wherein the first generative pre-trained transformer is operated depending on the second input data in order to generate second output data;
wherein a second generative pre-trained transformer is operated depending on the second input data in order to generate the second output data; and
wherein the vehicle functionality is operated depending on the second output data.

2. The method according to claim 1, wherein the first generative pre-trained transformer is configured to generate the first output data in consideration of driving situation data corresponding to a driving situation relating to the vehicle, of occupant status data corresponding to a status of a vehicle occupant, or of vehicle status data corresponding to a status of the vehicle, including a status of one or more devices or vehicle functionalities of the vehicle.

3. The method according to claim 1, wherein the second generative pre-trained transformer is configured to actuate, set, or execute the vehicle functionality.

4. The method according to claim 2, wherein the second generative pre-trained transformer is configured to actuate, set, or execute the vehicle functionality.

5. The method according to claim 1, wherein
two or more second generative pre-trained transformers are operated depending on the second input data in order to each generate the second output data;
third input data are generated depending on the second output data;
the first generative pre-trained transformer is operated depending on the third input data in order to generate third output data; and
the vehicle functionality is operated depending on the third output data.

6. The method according to claim 2, wherein
two or more second generative pre-trained transformers are operated depending on the second input data in order to each generate the second output data;
third input data are generated depending on the second output data;
the first generative pre-trained transformer is operated depending on the third input data in order to generate third output data; and
the vehicle functionality is operated depending on the third output data.

7. The method according to claim 5, wherein the first generative pre-trained transformer is configured to generate the third output data in consideration of driving situation data corresponding to a driving situation relating to the vehicle, of occupant status data corresponding to the status of a vehicle occupant, or of vehicle status data corresponding to the status of the vehicle, including a status of one or more devices or the vehicle functionalities of the vehicle.

8. The method according to claim 1, wherein the vehicle functionality influences a movement of the vehicle, including a drive system, a braking system, a steering system or maneuver execution system.

9. The method according to claim 1, wherein the vehicle functionality is a navigation system or a vehicle functionality related to assisted, automated, or autonomous driving of the vehicle.

10. The method according to claim 1, wherein the vehicle functionality is a multimedia system, an infotainment system, a personalization system, or a comfort function of the vehicle, including an air conditioner, a ventilation function, a scenting function, or one or more adjustable devices in a vehicle interior, including one or more segments of a seat or a steering wheel.

11. The method according to claim 1, wherein the first generative pre-trained transformer is post-trainable or is post-trained depending on driving situation data corresponding to a driving situation relating to the vehicle, on occupant status data corresponding to a status of a vehicle occupant, or on vehicle status data corresponding to a status of the vehicle, including a status of one or more devices or the vehicle functionalities of the vehicle.

12. A device for operating a vehicle, the device comprising:
a first control unit configured to ascertain a target to be achieved by a vehicle functionality and to generate first input data depending on the target;
a second control unit configured to operate a first generative pre-trained transformer in order to generate first output data depending on the first input data, and to generate second input data depending on the first output data;
wherein either the second control unit is configured to operate the first generative pre-trained transformer in order to generate second output data depending on the second input data; or
wherein the device comprises at least one third control unit configured to operate a second generative pre-trained transformer depending on the second input data in order to generate the second output data;
wherein either the second control unit or the third control unit are configured to operate the vehicle functionality depending on the second output data.

13. A computer program product comprising a computer program, wherein the computer program is designed to carry out the method according to claim 1 when the computer program is executed on one or more control units.

14. The computer program product according to claim 13, wherein the computer program comprises a first generative pre-trained transformer or a second generative pre-trained transformer, including a respective pre-trained model, or logic or data for training, including post-training, or for operating the first or second generative pre-trained transformer.
